(19) United States
(12) Patent Application Publication
(10) Pub. No.: US 2020/0078659 A1
(43) Pub. Date: Mar. 12, 2020

(54) APPARATUS AND SYSTEM FOR INDICATING PACE OF PLAY OF SPORT'S GAME

(71) Applicant: Peter Dunlea, Killarney (IE)

(72) Inventor: Peter Dunlea, Killarney (IE)

(21) Appl. No.: 16/466,172

(22) PCT Filed: Dec. 4, 2017
(86) PCT No.: PCT/IB2017/057613

§ 371 Date: Jun. 3, 2019

(30) Foreign Application Priority Data
Dec. 5, 2016 (IE) 20160272

(51) Int. Cl. A63B 71/06; G07C 1/22

(52) U.S. Cl. CPC A63B 71/0686; A63B 2220/62; G07C 1/22

(57) ABSTRACT

Provided are an apparatus and system for indicating pace of play of a sport's game, the apparatus comprising: a sensor for sensing a first wireless signal including timing information emitted by a tag associated with a first player; a microprocessor configured to receive the first wireless signal, transmit the first signal to a central processing station for comparison with times of other players or groups, and receive a second signal from the central processing station indicating the pace of play of the first player; and a signal display device being configured to receive a third signal from the microprocessor according to the pace of play of the first player and render according to the third signal a light signal indicative of the pace of play of the first player.

### FIELD OF THE INVENTION

The present disclosure relates to a system for indicating the pace of play or any interval monitoring for sport. More particularly, the present disclosure relates to a pace of play monitoring and indicating system for the game of golf.

### BACKGROUND OF THE DISCLOSURE

The pace of play on a golf course is critical to the successful operation of a golf facility. In order to successfully manage pace on a golf course, it is vital that the overall pace of lead groups and the intervals between successive groups (i.e., the cycle time) be carefully monitored and controlled.

In order to successfully manage pace of play, three key elements must be measured and controlled:
the agreed pace of play for the day
the starting interval
the cycle time between successive groups

Currently, one method of monitoring these key timing metrics is through the use of a golf-cart based GPS tracking system. This system incorporates a GPS tracking and mapping system on individual golf carts. Zones around the golf course are created such that, as the cart moves through the golf course, the time when the golfer starts and completes each hole, for example, can be measured. The position of the cart and these times may then be relayed to a central processing station where the golf course operator can monitor the progress of each cart. Management decisions based on such timing data can be made accordingly.

There are a number of drawbacks with such cart based systems. A golf course may typically have 75, 100 or more golf carts and so the cost of employing the GPS tracking can be prohibitively expensive. Also, not all golfers elect to use carts.

Other systems that are used include a pace of play monitoring system for a golf course comprising a plurality of sensors. Each sensor is disposed at a respective hole of the golf course for sensing removal of a flagstick from the respective hole and emitting a first signal in response thereto and for sensing a subsequent return of the flagstick into the hole and emitting a second signal in response thereto. A receiver remote from said plurality of sensors is configured for receiving said first signal and said second signal from each respective sensor, said receiver having a timing device for recording a time of arrival of each said first signal and said second signal from each said sensor. However, with this system, there is a need for a member of the course staff to intervene and move the golfers on to try and catch up on play.

Another system employs radio frequency identification (RFID) tags carried by the golfer and a system of RFID readers placed throughout the golf course, similar to timing systems used for running and other multisport races. Such a system also has significant drawbacks as the cost and power requirements for a long range RFID reader would require to be hard wired to the electricity grid.

Accordingly, it is an object of the present disclosure to provide a relatively inexpensive, simplified, reliable self-monitoring system to try and speed up the pace of play of a golf game.

### SUMMARY OF THE INVENTION

The present disclosure provides an apparatus as detailed in claim 1. Certain exemplary, advantageous features are provided in dependent claims.

Briefly, the present disclosure takes advantage of the fact that every golfer generally carries either a member's tag or guest tag on their bag to play any course. Such a tag may be fitted with a Bluetooth (RTM) low energy (BLE) device. The tag may thus be configured to energise a reader in a signal display device or similar static information board, fitted with indicator lights and the Bluetooth (RTM) or similar reader, to show players how their pace of play is on the particular hole.

In accordance with the present disclosure, the system when activated by individual tags within its range will evaluate if the player is within the threshold of the pace of play for the day or within a specified acceptable gap from the previous golfer. The system may then be configured to send a signal to the signal display device indicating the player's pace of play, e.g., green for on time, amber to pick up the pace, and red for indicating that the player is well behind the pace of play. The system may be configured to send alerts to course staff. For example, if a group is shown two red lights in succession, a text message may be sent to on-course staff to alert them to the hold-up.

### BRIEF DESCRIPTION OF THE DRAWINGS

FIGS. 1a and 1 b illustrate a member's or visitor's tag;

FIGS. 2a and 2b illustrate an apparatus for indicating pace of play of a sport's game, according to an embodiment of the present disclosure;

FIGS. 3a and 3b illustrate an apparatus for indicating pace of play of a sport's game, according to another embodiment of the present disclosure;

FIG. 4 is a block diagram illustrating an apparatus for indicating pace of play of a sport's game and a central processing station, according to an embodiment of the present disclosure;

FIG. 5 is a block diagram illustrating a configuration of a central processing station including various hardware and software components that function to perform the methods according to embodiments of the present disclosure.

### DETAILED DESCRIPTION

The present disclosure provides a monitoring system for recording the time of a sensed wireless tag associated with a player and then selecting which indicator light to display on an apparatus for indicating pace of play of a sport's game in the vicinity of the player.

The present disclosure may be applied to a variety of sports in which a plurality of players are participating simultaneously. The present disclosure is particularly suited to golf. The present disclosure takes advantage of the fact that every golfer generally carries either a member's tag or guest tag on their bag to play any course.

Such a tag may be fitted with a Bluetooth (RTM) low energy (BLE) device. The tag may thus be configured to energise a reader in a signal display device or similar static information board, fitted with indicator lights and the reader, to show players how their pace of play is on the particular hole.

The apparatus for indicating pace of play of a sport's game according to the present disclosure comprises a microprocessor. The microprocessor may be powered by a wired connection to a mains power or a low voltage source. The microprocessor may be powered by a battery housed in the apparatus. The battery may be replaceable or may be rechargeable. A rechargeable battery may be charged either through a direct wired connection or by an inductive means. Additionally, in order to prolong battery life, the system may incorporate a small solar cell, most preferably located at the top of the apparatus. The microprocessor may include one or more low power modes in order to prolong battery life.

The microprocessor may include systems permitting one or two-way communication with a central processing station of the monitoring system.

The timing of the BLE device sensed by the sensor may be communicated to the central processing station via any means. These means are preferably a wired, wireless electronic or optical communication, and most preferably by means of a wireless communication. The communication may be directly or indirectly sent to the central processing station across a network. The network may comprise any network across which communications can be transmitted and received. For example, the network may comprise a wired or wireless network. The network may, for example, comprise one or more of: the Internet; a local area network; a mobile or cellular network; a mobile data network or any other suitable type of network.

In the case of a wireless transmission, the apparatus may be equipped with an internal or external antenna to improve the data transmission reception. Bluetooth (RTM) tag timing communication may be sent immediately following the activation of the sensor or may be sent at regular or irregular intervals. Communication may include either single Bluetooth (RTM) tag events or multiple Bluetooth (RTM) tag events that may be communicated in a single packet in order to reduce power consumption.

Further features to reduce power consumption and prolong battery life may be incorporated into the system. These features may include, for example a low power mode at night time activated by either a clock internal to the microprocessor or a signal from the central processing station.

In addition to the BLE device timing and indicator light activation, the transmitted data may also include other useful information such as:
identification number of the tag
status information of system (battery level, faulty sensor, and the like)

The central processing station may be the final destination of the data or, preferably, the central processing station will be connected to the Internet or another data network via either a wired or wireless connection. The data may then be sent, over the Internet or data network to additional receivers for processing.

The position of each group on the golf course may be inferred through the timing data at the central processing station or to additional receivers. Since the position of individual groups is not tracked explicitly, the system may incorporate methods and algorithms for improving group tracking. These may include, but are not limited to:
confirmation of group position to the golf course personnel using either the central processing station or via software applications on or through a smart phone, tablet, computer and the like.
heuristic or probabilistic algorithms
software applications on individual golfer's smart phones

The data is processed and several important timing metrics may be reported at the central processing station and/or additional receivers. The metrics include, but are not limited to:
pace and position of individual groups
intervals between groups at individual holes (i.e., cycle time)

Data reports may be in tabular or graphical formats and may or may not include maps of the golf course. In addition to the data, the system may be programmed to provide alerts to golf course personnel and/or individual golfers. These alerts may include, but are not limited to:
groups who are beyond a stipulated pace
gaps between groups that exceed stipulated limits

The reporting of alerts may be in the form of:
messages on the central processing station and/or additional receivers
messages relayed to golf course personal on their cell phones or wireless radios. Such messages may be text (SMS messaging, app alerts, and the like) or audio
messages relayed to individual golfers on their cell phones. Such messages may be text (SMS messaging, app alerts, and the like) or audio

Golf course personnel may then take actions to improve pace of play when alerted by, for example:
requesting golfers to speed up their play
requesting or compelling golfers to use forward tees
requesting or compelling golfers to skip a hole or multiple holes to return to their proper position
metering the flow of golfers onto the golf course to prevent later backups.

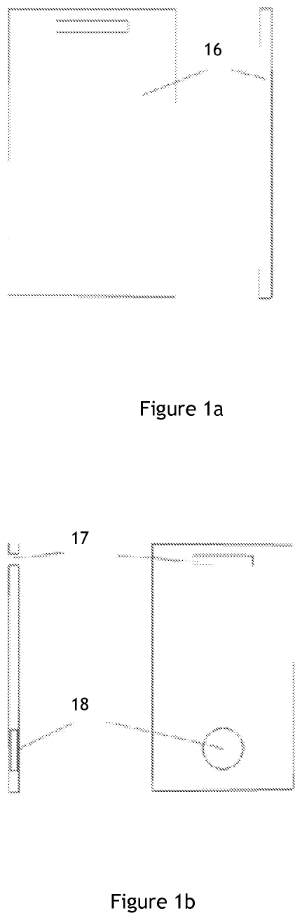

FIGS. 1a and 1b illustrate a member's or visitor's tag 16. Referring to FIG. 1b, the tag 16 may include a strap slot 17. The tag 16 may be configured to include a Bluetooth (RTM) low energy (BLE) device 18. Referring to FIGS. 1a and 1b, the BLE device 18 may be imbedded in the tag 16 with the slot 17 provided at the top for a strap and a printable flat section in the main part of the tag 16 to individualize for each club. The BLE device 18 may be configured to send a signal every 2 seconds as to allow a battery life of more than 24 months.

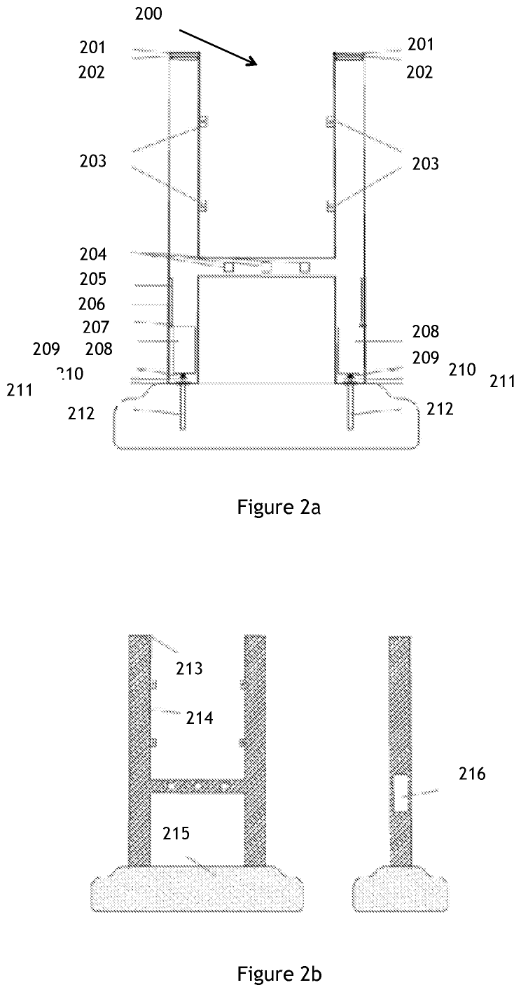

FIGS. 2a and 2b illustrate an apparatus 200 for indicating pace of play of a sport's game, according to an embodiment of the present disclosure. Referring to FIG. 2a, the apparatus 200 may comprise a mobile apparatus suitable for installing on a golf course, for example in the vicinity of a tee or green. Referring to FIG. 2a, the apparatus 200 comprises a beacon sensor comprising a BLE reader 205, a microprocessor 206, and light indictors 204 to indicate pace of play. The light indictors 204 may comprise LED lights. The light indicators 204 may comprise red, amber and green light indicators. The apparatus 200 according to the present embodiment has a H frame structure 214. The H frame structure 214 may be fitted with brackets 203 to allow individual signage be attached for each club. The H frame structure 214 may be bolted 210, 111 and 212 to a weighted base 215. A top of the H frame structure 214 may be fitted with a solar panel 202 that may be sealed to the frame by a plastic cap 201. The solar panel 202 may be fitted to the microprocessor 206 that will allow it to recharge a battery 208 when required. The microprocessor 206 may be configured to be connected to a mains power supply through a charging connection 207 on the side of the post. An induction charging system may also be incorporated. The BLE reader 205 when activated by a BLE chip 18 in the tag 16 may determine what light indicators 204 are activated. The light indicators 204 may be configured to remain on for a set time. The information on the appropriate time or acceptable intervals may be received by the microprocessor 206 by way of a transceiver such as a GSM or similar wireless transceiver. The transceiver may comprise a communication interface that is operatively connected to the microprocessor 206 and may be any interface that enables communication between the apparatus 200 and the central processing station. The microprocessor 206 may be configured to be in signal communication to the central processing station. The time at which the BLE device 18 is read may be sent back to the central processing station to be processed and be displayed on multi devices. In the event that a BLE device 18 is behind the pace of play on two consecutive occasions, a message may be sent to the on course staff.

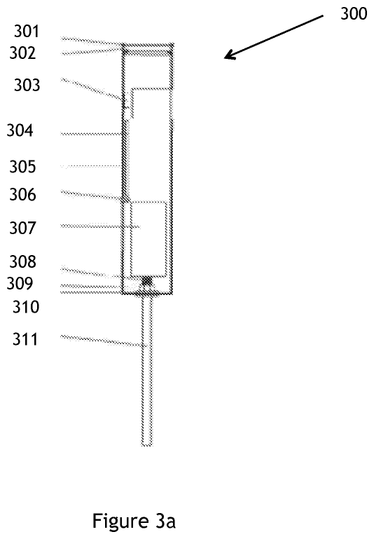

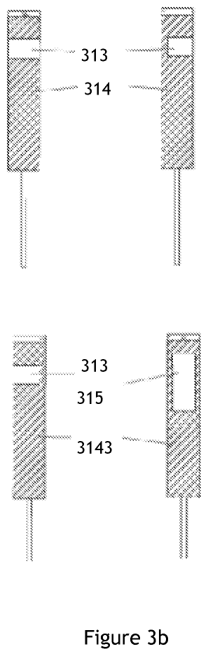

FIGS. 3a and 3b illustrate an apparatus 300 for indicating pace of play of a sport's game, according to another embodiment of the present disclosure. The apparatus 300 of FIGS. 3a and 3b comprises a mobile bollard type unit. The apparatus 300 includes a beacon sensor comprising a BLE reader 305 and a microprocessor 306 and light indictors 303 to indicate pace of play. The light indictors 303 may comprise LED lights. The apparatus 300 of FIGS. 3a and 3b has the same technology as that of the apparatus 200 of FIG. 2, but is incorporated in a housing 314 with a post 311 attached to the base. A signal diffused lens 313 may be attached to the housing 314 to allow coloured light to be omitted. Referring to FIGS. 3a and 3b, the apparatus 300 according to the present embodiment also comprises a plastic seal 301, a solar panel 302, the light indicators 303, a GSM device 304, the microprocessor 306, the BLE reader 305, a battery 307, a threaded bar 308, a nut 309, a washer 310, and an access panel 315.

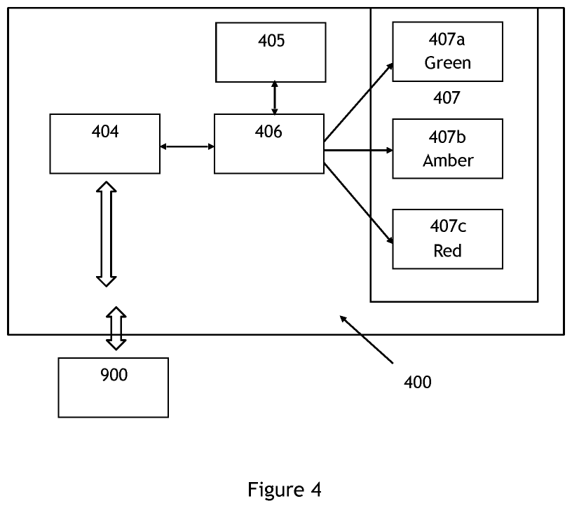

FIG. 4 illustrates an apparatus 400 for indicating pace of play of a sport's game and a central processing station 900, according to an embodiment of the present disclosure. Referring to FIG. 4, the apparatus 400 comprises a transceiver 404, a beacon sensor 405, a microprocessor 406, and a signal display device 407 including light indicators 407a, 407b and 407c. In operation, the microprocessor 406 receives Bluetooth (RTM) tag signals sensed by the beacon sensor 405. The signals may represent a change in voltage or current level using an analog-to-digital converter and may also be a simple digital voltage level state change. The microprocessor 406 preferably incorporates data reduction algorithms to limit the transmission of data to the central processing station 900. This preferably includes a minimum time between replacement signals. For example, if two BLE tag events are detected within a specified length of time, preferably 10 minutes, or more preferably within 5 minutes and most preferably within 3 minutes, the algorithm will send only the last BLE tag event with the presumption that the first BLE tag event was by the same group. The time of the BLE tag event may be recorded by the microprocessor 406 using an internal clock. The microprocessor 406 may then transmit the time of the event(s) as well as an identification number of the particular BLE tags to the central processing station 900 via the transceiver 404. In operation, the microprocessor 406 receives a first Bluetooth (RTM) tag signal, associated with a first player, sensed by the beacon sensor 405. The microprocessor 406 then transmits via the transceiver 404 the first signal to the central processing station 900 for comparison with times of other players or groups. The first signal is processed by the central processing station 900, and a second signal is received from the central processing station 900 indicating the pace of play of the first player. The signal display device 407 is configured to receive a third signal from the microprocessor 406 according to the pace of play of the first player and render according to the third signal a light signal indicative of the pace of play of the first player. The light signal comprises a green light signal 407a for indicating the first player is on time, an amber light signal 407b for indicating that the first player needs to increase their pace of play, or a red light signal 407c for indicating the first player is behind the pace of play.

In accordance with the present disclosure, the pace of play on a golf course may be easily established by monitoring the progression of the BLE events for the first group of the day at each hole. Successive events may be interpreted as indicative of the intervals time between successive groups. As described above, algorithms in the microprocessor (or interchangeably in the central processing station) may be configured to substantially eliminate spurious and false events such that the timing data will accurately measure the interval time between successive groups.

Typically, golf courses utilise a starting time scheduling software application. This information may be transmitted to the central processing station along with the Unique Bluetooth (RTM) Tag number. The actual starting time of any group will be read at the first tee box by one of the beacon sensors.

The pace of play for the any group or individual may be controlled by the activation of the beacon sensor on the first hole. The beacon sensor communicates with the central processing station and the pace of play for that group or individual may be sent to each beacon sensor on the course, the progression of the group or individual around the course and the progression relative to an established norm. If the group or individual is behind the established norm on two consecutive occasions, the golf course operator may then take measures to re-establish their position and pace. Such measures could include, but are not limited to:
requesting golfers to speed up their play
requesting or compelling golfers to use forward tees
requesting or compelling golfers to skip a hole or multiple holes to return to their proper position

The interval time between successive groups may be monitored relative to an established norm and may take priority over the recommended pace of play for the day. Again, if a group is determined to be behind the established norm, the golf course operator may take measures to re-establish their position and pace. Such measures may include, but are not limited to:
requesting golfers to speed up their play
requesting or compelling golfers to use forward tees
requesting or compelling golfers to skip a hole or multiple holes to return to their proper position

Additionally, individual holes may be analysed for chronically excessive interval times. The golf course operator may then take measures to reduce such excessive interval times. Such measures may include, but are not limited to:
shortening the hole
locating the hole in easier locations on the green
reducing size and/or difficulty of hazards

The present disclosure thus provides a simplified and reliable system for monitoring the pace of play of a golf game. In particular, the present disclosure incorporates monitoring the pace of play of a golf game into the actual real-time playing experience of a group of players.

The present disclosure provides a system for monitoring pace of play of a sport's game. The system comprises a plurality of the apparatus described above, each being disposed at a respective different location of a course; and a central processing station for processing signals received from the plurality of apparatus, recording times of the receipt of the signals determining the pace of play, determining the pace of play of a plurality of players associated with the signals received from the plurality of apparatus, wherein the central processing station is configured to be in signal communication with each of the plurality of apparatus.

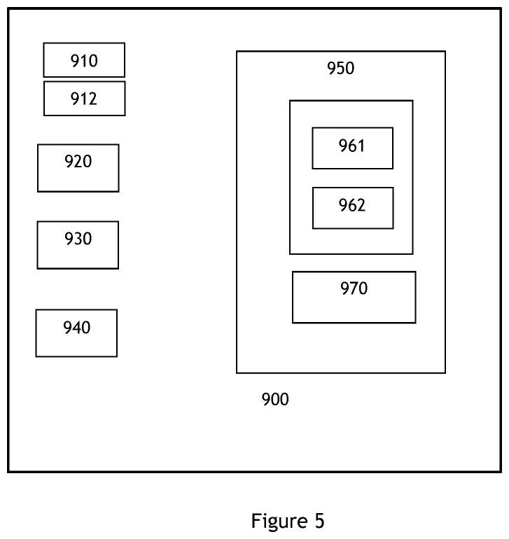

FIG. 5 is a block diagram illustrating a configuration of a central processing station 900 according to an embodiment of the present disclosure. The central processing station 900 includes various hardware and software components that function to perform the methods according to the present disclosure. Referring to FIG. 5, the central processing station 900 comprises a user interface 910, a processor 920 in communication with a memory 950, and a communication interface 930. The processor 920 functions to execute software instructions that can be loaded and stored in the memory 950. The processor 920 may include a number of processors, a multi-processor core, or some other type of processor, depending on the particular implementation. The memory 950 may be accessible by the processor 920, thereby enabling the processor 920 to receive and execute instructions stored on the memory 950. The memory 950 may be, for example, a random access memory (RAM) or any other suitable volatile or non-volatile computer readable storage medium. In addition, the memory 950 may be fixed or removable and may contain one or more components or devices such as a hard drive, a flash memory, a rewritable optical disk, a rewritable magnetic tape, or some combination of the above.

One or more software modules 960 may be encoded in the memory 950. The software modules 960 may comprise one or more software programs or applications 961 and 962 having computer program code or a set of instructions configured to be executed by the processor 920. Such computer program code or instructions for carrying out operations for aspects of the systems and methods disclosed herein may be written in any combination of one or more programming languages.

During execution of the software modules 960, the processor 920 configures the central processing station 900 to perform various operations relating to the processing of steps according to embodiments of the present disclosure, as has been described above.

Other information and/or data relevant to the operation of the present systems and methods, such as a database 970, may also be stored on the memory 950. The database 970 may contain and/or maintain various data items and elements that are utilized throughout the various operations of the system described above. It should be noted that although the database 970 is depicted as being configured locally to the central processing station 900, in certain implementations the database 970 and/or various other data elements stored therein may be located remotely. Such elements may be located on a remote device or server—not shown, and connected to the central processing station 900 through a network in a manner known to those skilled in the art, in order to be loaded into a processor and executed.

Further, the program code of the software modules 960 and one or more computer readable storage devices (such as the memory 950) form a computer program product that may be manufactured and/or distributed in accordance with the present disclosure, as is known to those of skill in the art.

The communication interface 940 is also operatively connected to the processor 920 and may be any interface that enables communication between the central processing station 900 and external devices, machines and/or elements. The communication interface 940 is configured for transmitting and/or receiving data. For example, the communication interface 940 may include but is not limited to a Bluetooth (RTM), or cellular transceiver, a satellite communication transmitter/receiver, an optical port and/or any other such, interfaces for wirelessly connecting the central processing station 900 to the other devices.

The user interface 910 is also operatively connected to the processor 920. The user interface may comprise one or more input device(s) such as switch(es), button(s), key(s), and a touchscreen.

The user interface 910 functions to allow the entry of certain information about the user and preferred options as discussed above. The user interface 910 functions to facilitate the capture of commands from the user such as an on-off commands or settings related to operation of the system.

A display 912 may also be operatively connected to the processor 920. The display 912 may include a screen or any other such presentation device that enables the user to view various options, parameters, and results. The display 912 may be a digital display such as an LED display. The user interface 910 and the display 912 may be integrated into a touch screen display.

The operation of the central processing station 900 and the various elements and components described above will be understood by those skilled in the art with reference to the system according to the present disclosure.

The present disclosure is not limited to the embodiment(s) described herein but can be amended or modified without departing from the scope of the present disclosure. Additionally, it will be appreciated that in embodiments of the present disclosure some of the above-described steps may be omitted and/or performed in an order other than that described.

1.-5. (canceled)

6. An apparatus for indicating pace of play of a sports game, the apparatus comprising:
a sensor for sensing a first wireless signal including timing information emitted by a tag associated with a first player;
a microprocessor configured to receive the first wireless signal, transmit the first signal to a central processing station for comparison with times of other players or groups, and receive a second signal from the central processing station indicating the pace of play of the first player;
a signal display device being configured to receive a third signal from the microprocessor according to the pace of play of the first player and render according to the third signal a light signal indicative of the pace of play of the first player.

7. The apparatus of claim 6, wherein the light signal comprises a green light signal for indicating the first player is on time, an amber light signal for indicating that the first player needs to increase their pace of play, or a red light signal for indicating the first player is behind the pace of play.

8. The apparatus of claim 6, wherein the sensor comprises a beacon sensor for sensing a Bluetooth (RTM) low energy (BLE) device in the tag.

9. The apparatus of claim 6, being configured for installation on a golf course, and being in the form of a mobile H-frame apparatus.

10. The apparatus of claim 6, being configured for installation on a golf course, and being in the form of a mobile bollard type unit.

11. The apparatus of claim 6 in which the sensor captures the timing of a first wireless signal emitted by a tag associated with a first player using an internal clock.

12. A system for monitoring pace of play of a sports game, comprising:
a plurality of apparatus for indicating pace of play of a sports game, each being disposed at a respective different location of a course, the apparatus comprising:
a sensor for sensing a first wireless signal emitted by a tag associated with a first player; a microprocessor configured to receive the first wireless signal, transmit the first signal to a central processing station for comparison with times of other players or groups, and receive a second signal from the central processing station indicating the pace of play of the first player; a signal display device being configured to receive a third signal from the microprocessor according to the pace of play of the first player and render according to the third signal a light signal indicative of the pace of play of the first player; and
a central processing station for processing signals received from the plurality of apparatus, recording times of the receipt of the signals determining the pace of play, determining the pace of play of a plurality of players associated with the signals received from the plurality of apparatus, wherein the central processing station is configured to be in signal communication with each of the plurality of apparatus.

13. The system of claim 12, wherein the light signal of the apparatus comprises a green light signal for indicating the first player is on time, an amber light signal for indicating that the first player needs to increase their pace of play, or a red light signal for indicating the first player is behind the pace of play.

14. The system of claim 12, wherein the sensor of the apparatus comprises a beacon sensor for sensing a Bluetooth (RTM) low energy (BLE) device in the tag.

15. The system of claim 12, wherein the apparatus is configured for installation on a golf course, and being in the form of a mobile H-frame apparatus.

16. The system of claim 12, wherein the apparatus is configured for installation on a golf course, and being in the form of a mobile bollard type unit.

17. The system of claim 12 in which the apparatus' sensor captures the timing of a first wireless signal emitted by a tag associated with a first player using an internal clock.

18. A method of indicating the pace of play of a golf game comprising the steps of:
providing a golfer with a tag having a wireless transmitter;
providing a plurality of beacon sensors at designated locations around a golf course, one on each hole of the golf course, each of the plurality of beacon sensors being operable to sense the tag when the tag is in the detection range of the beacon sensor;
determining the time it has taken the golfer to complete a hole of the golf course and evaluating if the golfer is within the threshold of the pace of play for the day or within a specified acceptable gap from a previous player for that hole;
operating a signal display device indicative of the golfers pace of play, including operating one of a green light on the signal display device to indicate that the golfer is on time for the preceding hole; an amber light on the signal display device to indicate that the golfer is outside the threshold of the pace of play or outside the specified acceptable gap from the previous player for the preceding hole and the golfer needs to speed up their play; and a red light on the signal display device to indicate that the golfer is well outside the threshold of the pace of play or well outside the specified acceptable gap from the previous player for the preceding hole and the golfer needs to take corrective action.

19. The method of indicating the pace of play of a golf game as claimed in claim 18 comprising the step of establishing the pace of play for the day by monitoring the progression of a first group of golfers at each hole on the golf course that day.

20. The method of indicating the pace of play of a golf game as claimed in claim 18 in which the method comprises the step of capturing the actual starting time of a golfer with a beacon sensor at a tee box of the first hole of the golf course.

21. A method of indicating the pace of play of a golf game as claimed in claim 20 in which the method comprises the step of, subsequent to the beacon sensor at the first tee box capturing the actual starting time of a golfer, transmitting the pace of play for that golfer to each of the other beacon sensors on the golf course.

22. A method of indicating the pace of play of a golf game as claimed in claim 18 in which on the golfer being outside the threshold of the pace of play or outside the specified acceptable gap from the previous player for two consecutive holes, alerting a golf course operator of the slow play and the golf course operator taking measures to re-establish the golfer's position on the golf course.

23. A method of indicating the pace of play of a golf game as claimed in claim 18 comprising the steps of: monitoring the interval time between successive groups of golfers on the golf course; prioritizing the interval time between successive groups over the pace of play for the day; and operating a signal display device indicative of the golfers pace of play dependent on the interval time between successive groups.

24. A method of indicating the pace of play of a golf game as claimed in claim 18 comprising the additional step of reporting an alert by relaying a message to a golf course personnel on one of a cell phone or wireless radio carried by the golf course personnel.

25. A method of indicating the pace of play of a golf game as claimed in claim 18 comprising the additional step of reporting an alert by relaying a message to a golfer on their cell phone.
